(19) United States
(12) Patent Application Publication
(10) Pub. No.: US 2011/0105328 A1
(43) Pub. Date: May 5, 2011

(54) HERBICIDAL FORMULATION

(75) Inventors: Michael Chavant, Berkshire (GB); John Nettleton-Hammond, Berkshire (GB); Ian Tovey, Berkshire (GB)

(73) Assignee: SYNGENTA LIMITED, Guildford, Surrey (GB)

(21) Appl. No.: 12/161,814

(22) PCT Filed: Jan. 22, 2007
(86) PCT No.: PCT/EP07/00512

§ 371 Date: Jan. 19, 2011

(30) Foreign Application Priority Data
Jan. 23, 2006 (GB) 0601304.9

(51) Int. Cl. A01N 57/20; A01P 13/00

(52) U.S. Cl. 504/128

(57) ABSTRACT

A herbicidal aqueous concentrate comprises from 0.05 to 8% w/v of an ALS inhibitor (especially an sulfonylurea and in particular trifloxysulfuron) and from 35 to 70% w/v expressed as glyphosate acid equivalent of a salt of glyphosate wherein the ratio of the cation to the N-phosphonomethylglycine anion in the salt of glyphosate is from 1.5 to 3.0. The concentrate shows improved storage stability. Optionally there may be added an agriculturally acceptable salt.

The present invention relates to a novel herbicidal formulation and in particular to a novel herbicidal formulation comprising glyphosate and an ALS inhibitor. The invention further relates to a method of improving the stability of an ALS inhibitor in water.

The protection of crops from weeds and other vegetation that inhibits crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use. Commercial herbicides and some that are still in development are described in The Pesticide Manual, 12^{th} edition, published in 2000 by the British Crop Protection Council.

Many herbicides also damage crop plants. The control of weeds in a growing crop therefore requires the use of so-called ‘selective’ herbicides, which are chosen to kill the weeds while leaving the crop undamaged. In practice, few herbicides are fully selective, in that they will kill some or all of the weeds and leave the crop untouched at a particular application rate. The use of most selective herbicides is actually a balance between applying enough herbicide to acceptably control most of the weeds and causing only minimal crop damage.

Glyphosate is a well-known herbicide, which for many years was used only as a non-selective herbicide. However, the development and commercialisation of glyphosate-tolerant crops has meant that glyphosate may be used on such crops to control undesirable weeds whilst providing little or no damage to the tolerant crop. Increasingly however certain weed species have themselves developed at least a partial resistance to glyphosate, which reduces the effectiveness of the herbicidal treatment. To counteract problems of glyphosate tolerance in weeds and provide residual control of weeds, the glyphosate may be combined with a second herbicide such as an ALS inhibitor, for example a sulfonylurea herbicide, which is selective in respect of the crop being treated. It is an advantage of ALS inhibitors such as sulfonylurea herbicides that they are very active and the composition therefore requires only a relatively small concentration of the selective herbicide relative to the glyphosate. However this advantage also gives rise to problems since many ALS inhibitors such as sulfonylurea herbicides have a relatively low chemical stability in water and tend to hydrolyse to an inactive degradation product with a consequent loss in activity. Whilst the rate of hydrolysis is not sufficient to affect the application of a freshly prepared aqueous spray, problems arise on storage of an aqueous composition and in particular in the commercialisation of a water-based concentrate intended for subsequent dilution and spray application. Hydrolysis of the active ingredient is of course an even greater problem in aqueous compositions containing low levels of ALS inhibitors such as sulfonylurea herbicides since any loss of active ingredient will result in a serious loss of activity.

Hitherto this problem has been solved by minimising the contact of the ALS inhibitors such as sulfonylurea herbicides with water, for example by selling the combination with glyphosate as a “twin pack” comprising a sulphonyl urea in the form of solid granules in one pack and glyphosate in a second pack. The packs are added together to water ready for spray application but are not mixed before then. This however is a cumbersome approach and there is a need for storage-stable aqueous concentrate formulation containing both glyphosate and an ALS inhibitor that can be stored without serious loss of active ingredient.

Glyphosate is normally sold as a salt of N-phosphonomethylglycine. Many salts have been marketed, including without limitation the isopropylamine salt, the ethanolamine salt, the trimethylsulphonium salt, the ammonium salt, the sodium salt and the potassium salt. In general glyphosate is sold as a concentrate of the salt in water and the ratio of the cation to the N-phosphonomethylglycine anion is generally about 1:1 on a molar basis i.e. the mono salt of N-phosphonomethylglycine. N-phosphonomethylglycine however is an acid having three replaceable acid moieties and therefore forms a mono- di- or tri-salt respectively with one, two or three anion moieties.

We have found that surprisingly the ratio of the cation to the N-phosphonomethylglycine anion together with the concentration of the glyphosate salt in the concentrate composition may be selected to provide a storage-stable aqueous concentrate comprising a relatively small concentration of ALS inhibitor.

Thus according to the present invention there is provided a storage-stable aqueous concentrate comprising from 0.05 to 8% w/v of an ALS inhibitor and from 35 to 70% w/v expressed as glyphosate acid equivalent of a salt of glyphosate wherein the ratio of the cation to the N-phosphonomethylglycine anion in the salt of glyphosate is from 1.5 to 3.0.

The term “storage-stable” as used herein should not be taken to mean that there is no detectable loss of active ingredient by hydrolysis. Rather the term is used to mean that the storage stability is acceptable in commercial practice. A concentrate may be considered to have commercially acceptable storage stability if there is less than 15% and more preferably less than 10% loss by weight of the ALS inhibitor in the concentrate at 40° C. over a period of 6 weeks.

The invention is especially applicable to ALS inhibitors which have a loss through hydrolysis of more than 15% by weight at a temperature of 20° C., preferably 30° C., in particular 40° C. over a period of 6 weeks in water at a concentration of 0.3% w/v and more preferably more than 10% in water at a concentration of 0.3% w/v at a temperature of 20° C., preferably 30° C., in particular 40° C. over a period of 6 weeks.

As examples of ALS inhibitors useful in the present invention there may be mentioned Imidazolinones: imazapic, imazapyr, imazaquin, imazamethabenz-methyl, imazamox, imazethapyr; Triazolopyrimidines: chloransulam-methyl, diclosulam, flumetsulam, florasulam, metosulam; Pyrimidinylthiobenzoates: bispyribac-Na, pyrithiobac-Na, pyriminobac-methyl, pyribenzoxim, pyriftalid; Sulfonylureas: foramsulfuram, flupyrsulfuron-methyl, azimsulfuron, amidosulfuron, cyclosulfamuron, nicosulfuron, oxasulfuron, tritosulfuron, bensulfuron-methyl, halosulfuron-methyl, pyrazosulfuron-ethyl, ethametsulfuron-methyl, thifensulfuron-methyl, chlorimuron-ethyl, imazosulfuron, rimsulfuron, triflusulfuron-methyl, ethoxysulfuron, primisulfuron-methyl, triasulfuron, chlorsulfuron, iodosulfuron, sulfometuron-methyl, flazasulfuron, prosulfuron, tribenuron-methyl, cinosulfuron, mesosulfuron, metsulfuron-methyl, sulfosulfuron, trifloxysulfuron; Sulfonylamino-carbonyl-triazolinones: flucarbazone-Na, propoxycarbazone-Na.

A particularly useful class of ALS inhibitors is the sulfonylureas. Herbicides classified as sulfonylureas are well known to those skilled in the art but specific examples include without limitation foramsulfuram, flupyrsulfuron-methyl, azimsulfuron, amidosulfuron, cyclosulfamuron, nicosulfuron, oxasulfuron, tritosulfuron, bensulfuron-methyl, halosulfuron-methyl, pyrazosulfuron-ethyl, ethametsulfuron-methyl, thifensulfuron-methyl, chlorimuron-ethyl, imazosulfuron, rimsulfuron, triflusulfuron-methyl, ethoxysulfuron, primisulfuron-methyl, triasulfuron, chlorsulfuron, iodosulfuron, sulfometuron-methyl, flazasulfuron, prosulfuron, tribenuron-methyl, cinosulfuron, mesosulfuron, metsulfuron-methyl, sulfosulfuron, trifloxysulfuron. Especially suitable ALS inhibitors for the aqueous concentrates according to the present invention are selected from the group consisting of pyriftalid, trifloxysulfuron, flazasulfuron, tribenuron, primisulfuron, sulfometuron-methyl and prosulfuron. Trifloxysulfuron is especially preferred as the ALS inhibitor component of the aqueous concentrates according to the present invention.

Sulfonylureas may be used in the present invention either as the free acid or in the form of an agrochemically acceptable salt. If desired the salt of the sulfonylurea may be formed at the same time that the ratio of the glyphosate anion to cation is adjusted. The sulfonylureas are typically formulated as an alkali metal salt such as sodium or potassium but there is no particular limitation and other salts such as the ammonium and isopropylamine salt may be used if desired. There may be practical advantages if the same cation is selected for the glyphosate and sulfonylurea anions but this is not essential.

The concentration of the ALS inhibitor such as the sulfonylurea in the composition is preferably from 0.1 to 5% w/v and more particularly from 0.1 to 1% w/v for example from 0.1 to 0.5%

It will be understood that the ratio of the cation to the N-phosphonomethylglycine anion in the salt of glyphosate represents an average value and that the mono- di- and tri-anions may all be present in varying proportions. Any suitable salt of N-phosphonomethylglycine may be used as the glyphosate salt but the potassium salt is particularly preferred. The invention will be illustrated with reference to the potassium salt of N-phosphonomethylglycine but this is not to be taken as limiting the invention to that salt. The ratio of the potassium cation to the N-phosphonomethylglycine anion is conveniently varied by adding potassium hydroxide to N-phosphonomethylglycine or equally to the monopotassium salt of N-phosphonomethylglycine. Addition of potassium hydroxide will alter the pH and as an approximate guide, a concentrate having a ratio of the potassium cation to the N-phosphonomethylglycine anion of 1 will have a pH of about 5 (1% dilution in water), a composition having ratio of the potassium cation to the N-phosphonomethylglycine anion of 2 will have a pH of about 7.5 and a composition having ratio of the potassium caion to the N-phosphonomethylglycine anion of 3.0 will have a pH of about 11. Thus the concentrate of the invention will typically have a pH of from 5.5 to 11.

The ratio of the potassium cation to the N-phosphonomethylglycine anion in the salt of glyphosate is preferably 2 to 3 and more preferably 2 to 2.5.

The concentration of glyphosate is conventionally expressed in terms of the concentration of the acid equivalent (i.e. as though the glyphosate were present in the form of free acid) even though a salt is used. A preferred concentration is from 35% w/v to 60% w/v acid equivalent.

We have found that the composition may be further stabilised by the addition of an agriculturally acceptable salt such as an inorganic salt or a salt of a carboxylic acid. Typical salts include an alkali metal halide such as potassium or sodium chloride, an ammonium salt such as ammonium sulphate, a phosphate salt such as potassium pyrophosphate, magnesium sulphate and potassium citrate.

The salt may be present at a concentration of from 0.1% to 15% w/v, more preferably from 3% to 10% w/v.

In the context of the present invention, the unit “% w/v” means percent weight per volume, for example 70% w/v expressed as glyphosate acid equivalent of a salt of glyphosate means 700 g glyphosate acid equivalent of a salt of glyphosate per litre of the prepared formulation. 0.05 to 8% w/v of an ALS inhibitor means 0.5 to 80 g of an ALS inhibitor per litre of the prepared formulation and 3% to 10% w/v of an additional salt means 30 to 100 g of salt per litre of the prepared formulation.

It will be appreciated that greater stabilisation will be achieved for a given concentration of ALS inhibitor in the presence of a salt and at higher concentrations of the glyphosate salt and/or at a higher ratio of the potassium cation to the N-phosphonomethylglycine anion. Thus, a lower concentration of glyphosate salt may achieve acceptable stabilisation in the presence of the salt than in the absence of the salt. Similarly, the addition of a salt may be unnecessary if glyphosate salt concentrations are used at the higher end of the range and/or if a higher ratio of the potassium cation to the N-phosphonomethylglycine anion is used.

The composition concentrate may comprise one or more conventional adjuvants. These may include, but are not restricted to, suspending agents, surfactants, buffers, stabilisers viscosity modifiers and biocides. Adjuvants may be included in the concentrate of the invention to enhance the efficacy of the active ingredients. A broad range of surface-active agents is advantageously employed in liquid compositions, especially those designed to be diluted with carrier before application. The surface-active agents can be anionic, cationic, nonionic or polymeric in character and can be employed as emulsifying agents, dispersants, wetting agents, suspending agents, or for other purposes. Typical surface active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C.sub.18 ethoxylate; alcohol-alkylene oxide addition products, such as tridecyl alcohol-C.sub.16 ethoxylate; soaps, such as sodium stearate; styrene based acrylic copolymers, alkylnaphthalenesulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; alkyl polyglycoside; quaternary amines, such as lauryl trimethylammonium chloride; polyethylene glycol esters of fatty acids, such as polyethylene glycol stearate; block copolymers of ethylene oxide and propylene oxide; and salts of mono and dialkyl phosphate esters.

Other adjuvants commonly utilized in agricultural compositions include crystallization inhibitors, viscosity modifiers, suspending agents, spray droplet modifiers, pigments, antioxidants, foaming agents, light-blocking agents, compatibilizing agents, antifoam agents, sequestering agents, neutralizing agents and buffers, corrosion inhibitors, dyes, odorants, spreading agents, penetration aids, micronutrients, emolients, lubricants, sticking agents, dispersing agents, thickening agents, freezing point depressants, antimicrobial agents, and the like. The compositions can also contain other compatible components, for example, other herbicides, herbicide safeners, plant growth regulants, fungicides, insecticides, and the like and can be formulated with liquid fertilizers or solid, particulate fertilizer carriers such as ammonium nitrate, urea and the like.

The composition of the present invention may be prepared in a variety of ways that will occur to one skilled in the art. For example a water-soluble or water-suspendable salt of the ALS inhibitor may be separately dissolved or suspended in water and the composition may be admixed with an aqueous glyphosate composition to form a composition of the present invention. The salt for example the alkali metal salt, if used, may be added directly or as an aqueous solution. Similarly any adjuvants may be added to any of the relevant solutions.

Alternatively the aqueous concentrate formulation of the invention can be made by preparing a millbase of the sulfonylurea, optionally in acid form, and then adding the millbase plus any additional adjuvants required, to the aqueous glyphosate composition.

Thus for example the glyphosate salt may be prepared by adding base such as potassium hydroxide to N-phosphonomethylglycine or alternatively adding base to a an existing monopotassium salt of N-phosphonomethylglycine. The optimum particle size of the sulfonyl urea is achieved by wet milling to generate a concentrated millbase or alternatively by other suitable comminution processes such as dry grinding. The sulfonylurea is then suitably incorporated into the glyphosate solution and the remaining formulants added.

In an alternative method (a “drown-out” crystallisation process) an aqueous solution of sulfonylurea is prepared and dispersed in glyphosate solution such that the high electrolyte environment forces crystallisation of the sulfonylurea.

The aqueous concentrate formulation (containing glyphosate and the ALS inhibitor) of the present invention may be used for the control of unwanted vegetation, particularly unwanted vegetation in a field of useful crops, including glyphosate resistant crops (including without limitation maize, soybean, cereals, sugarbeet, turf; canola, and cotton) in respect of which the relevant ALS inhibitor is selective. In a particularly preferred embodiment the ALS inhibitor is a sulfonylurea, and in particular trifloxysulfuron, and the crop is glyphosate tolerant cotton.

Crops are to be understood as including those crops that have been made tolerant to glyphosate by conventional methods of breeding or gene technology. Some crops such as tree crops are naturally tolerant through herbicide placement. The aqueous concentrate formulation of the present invention is similarly useful for non-crop applications such as vegetative control where the ALS inhibitor (for example a sulfonylurea such as trifloxysulfuron) provides increased weed spectrum control.

Before use, the aqueous concentrate formulation of the present invention is suitably first diluted, preferably with water, by between 2 and 500 times.

A further aspect of the invention provides a process for the control of unwanted vegetation, in particular unwanted vegetation in a field of useful crops, said process comprising the dilution of an aqueous concentrate formulation of the invention to form a ready-to-use aqueous formulation, followed by the application of a herbicidally effective amount of said ready-to-use aqueous formulation to the locus of the unwanted vegetation.

A ‘herbicidally effective amount’ is the quantity of the ready-to-use formulation, which is capable of producing a controlling or modifying effect on the growth of weeds. Typical application rates are 50 to 4200 g glyphosate (acid equivalent)/hectare, preferably 500 to 1500 g glyphosate (acid equivalent)/hectare and from 1 to 200 g/ha sulfonylurea preferably from 1 to 100 g sulfonylurea/hectare, for example from 1 to 30 g/ha (based on acid equivalent) of trifloxysulfuron and more particularly from 1 to 15 g/ha (based on acid equivalent) of trifloxysulfuron.

Controlling or modifying effects include all deviation from natural development, for example, non-germination of seeds, plant death, retardation or growth, leaf burn, albinism, dwarfing and the like.

‘Locus’ means any part of the plants themselves, their seeds, or the ground or other medium where such plants might germinate or grow.

The ready-to-use aqueous composition may be applied by any of the usual application methods known in agriculture, most preferably by spraying.

The present invention will now be illustrated by means of the following non-limiting examples:

### General Method

The compositions of the invention and corresponding comparisons were prepared by the following general method:

A 40% w/w trifloxysulfuron-Na millbase was prepared, which also contains Morwet D425 (4%) and tap water (to 100%) (Morwet is a trade name). A conventional high shear mixer and then a conventional wet bead mill were used to mix and comminute the millbase to give an approximate mean particle size of 1-3 microns.

The final suspension was prepared by firstly adjusting a stock solution of the monopotassium salt of N-phosphonomethylglycine to required pH, by addition of potassium hydroxide pellets. Once adjusted a pre-prepared Kelzan gel containing Proxel GXL as biocide and the trifloxysulfuron-Na millbase were homogenised into the batch using a saw tooth or equivalent shear mixer.

### Comparison

In this comparison, the ratio of the potassium cation to the glyphosate anion was 1.1 to 1 and the pH approximately 5

| | Comparison 1 | Comparison 2 | Comparison 3 | Comparison 4 | Comparison 5 |
|---|---|---|---|---|---|
| Constituent name | g/L | g/L | g/L | g/L | g/L |
| Glyphosate | 360 | 360 | 360 | 360 | 360 |
| (as potassium; | | | | | |
| GLYH₂^{-1.1}; pH ~5) | | | | | |
| Trifloxysulfuron | 2.27 | 2.27 | 2.27 | 2.27 | 2.27 |
| (as sodium salt) | | | | | |
| Potassium chloride | | 63.22 | | | |
| Magnesium sulphate | | | | | 102.07 |
| Potassium citrate | | | | 48.8 | |
| Ammonium sulphate | | | 112.04 | | |
| Morwet D425 | 0.227 | 0.227 | 0.227 | 0.227 | 0.227 |
| Kelzan | 1.5 | 1.5 | 1.5 | 1.5 | 1.5 |
| Proxel GXL | 0.2 | 0.2 | 0.2 | 0.2 | 0.2 |
| Water | to 1 Litre | to 1 Litre | to 1 Litre | to 1 Litre | to 1 Litre |
| % Trifloxysulfuron loss | 27% | 10% | 22% | 15% | 45% |
| after 6 weeks/40° C.) | | | | | |

### EXAMPLES 1 TO 3

In Examples 1 to 3 the ratio of the potassium cation to the glyphosate anion was 2.0 to 1 (potassium; GLYH₂^{-2.0}) and the pH was about 8

| | Example 1 | Example 2 | Example 3 |
|---|---|---|---|
| Constituent name | g/L | g/L | g/L |
| Glyphosate | 360 | 360 | 360 |
| (as potassium; | | | |
| GLYH₂^{-2.0}; pH ~8) | | | |
| Trifloxysulfuron | 2.27 | 2.27 | 2.27 |
| (as sodium salt) | | | |
| Potassium chloride | | | 63.22 |
| Sodium chloride | | 63.22 | |
| Morwet D425 | 0.227 | 0.227 | 0.227 |
| Kelzan | 1.5 | 1.5 | 1.5 |
| Proxel GXL | 0.2 | 0.2 | 0.2 |
| Water | to 1 Litre | to 1 Litre | to 1 Litre |
| % Trifloxysulfuron loss | 19% | 8% | 3.8% |
| after 6 weeks/40° C.) | | | |

### EXAMPLES 4 TO 7 AND COMPARISONS 6 AND 7

In these Examples and Comparisons the ratio of the potassium cation to the glyphosate anion was as indicated where GLYH₂^{-x} indicates that the ratio of the potassium cation to the glyphosate anion is x to 1.

| | Comparison 6 | | Example 4 | Example 5 | Example 6 | Example 7 |
|---|---|---|---|---|---|---|
| Constituent name | g/L | Comparison 7 | g/L | g/L | g/L | g/L |
| Glyphosate (as potassium; | 480 | 480 | | | | |
| GLYH₂^{-1.1}; pH ~5) (Comparison) | | | | | | |
| Glyphosate | | | 480 | 480 | | |
| (as potassium; GLYH₂^{-2.0}; pH ~8) | | | | | | |
| Glyphosate | | | | | 480 | |
| (as potassium; GLYH₂^{-2.1}; pH ~9) | | | | | | |
| Glyphosate | | | | | | 480 |
| (as potassium; GLYH₂^{-2.5}; pH ~10) | | | | | | |
| Trifloxysulfuron (as sodium salt) | 3.03 | 3.03 | 3.03 | 3.03 | 3.03 | 3.03 |
| Potassium chloride | | 63.22 | | 63.22 | | |
| Morwet D425 | 0.3 | 0.3 | 0.3 | 0.3 | 0.3 | 0.3 |
| Kelzan | 1.5 | 1.5 | 1.5 | 1.5 | 1.5 | 1.5 |
| Proxel GXL | 0.2 | 0.2 | 0.2 | 0.2 | 0.2 | 0.2 |
| Water | to 1 Litre | to 1 Litre | to 1 Litre | to 1 Litre | to 1 Litre | to 1 Litre |
| % Trifloxysulfuron loss | 16% | 48% | 3% | 31% | 0% | 0% |
| after 6 weeks/40° C.) | | | | | | |

### EXAMPLES 8 AND 9 AND COMPARISON 8

| | Comparison 8 | Example 8 | Example 9 |
|---|---|---|---|
| Constituent name | g/L | g/L | g/L |
| Glyphosate | 600 | | |
| (as potassium; | | | |
| GLYH₂^{-1.1}; pH ~5) | | | |
| Glyphosate | | 600 | |
| (as potassium; | | | |
| GLYH₂^{-2.0}; pH ~8) | | | |
| Glyphosate | | | 600 |
| (as potassium; | | | |
| GLYH₂^{-2.5}; pH ~10) | | | |
| Trifloxysulfuron | 3.78 | 3.78 | 3.78 |
| (as sodium salt) | | | |
| Potassium chloride | | | |
| Morwet D425 | 0.378 | 0.378 | 0.378 |
| Kelzan | 1.5 | 1.5 | 1.5 |
| Proxel GXL | 0.2 | 0.2 | 0.2 |
| Water | to 1 Litre | to 1 Litre | to 1 Litre |
| % Trifloxysulfuron loss | 17.60% | 6% | 0% |
| after 6 weeks/40° C.) | | | |

### EXAMPLES 10 to 14

Examples containing prosulfuron, primisulfuron and pyriftilid were prepared and formulated as described in the general method above.

Further examples included for corresponding comparison were prepared by the following general method:

Initially 10% w/w (total active ingredient) premixes of Katana® (flazasulfuron), Quantum® (tribenuron-methyl), Oust® (sulfometuron-methyl) were prepared by dispersing the product into water containing a nominal amount of Morwet D425.

The final suspension was prepared by firstly adjusting a stock solution of the monopotassium salt of N-phosphonomethylglycine to required pH, by addition of potassium hydroxide pellets. In these examples, the ratio of the potassium cation to the glyphosate anion was adjusted to 1.1 to 1 to achieve a pH of approximately 5 (comparative examples) and 2.5 to 1 to achieve a pH of approximately 10. Once adjusted a pre-prepared Kelzan gel containing Proxel GXL as biocide and the comparative premix were homogenised into the batch using a saw tooth or equivalent shear mixer. Samples were prepared at 480 g/L of the monopotassium salt of N-phosphonomethylglycine and 5 g/L or 50 g/L equivalent active ingredient content (ALS inhibitor) and percentage loss of active ingredient measured after storage at elevated temperatures.

5 g/L Active Ingredient content (480 g/L of the monopotassium salt of N-phosphonomethylglycine)

| | | % AI loss | % AI loss |
|---|---|---|---|
| | | after 4 weeks | after 2 weeks |
| Active ingredient | pH | at 40° C. | at 54° C. |
| flazasulfuron (as | 5 (comparison) | 30 | 95 |
| Katana ®) Example 10 | 10 | 0 | 52 |
| tribenuron-methyl (as | 5 (comparison) | 96 | 100 |
| Quantum ®) Example 11 | 10 | 37 | 91 |
| prosulfuron | 5 (comparison) | 57 | 100 |
| Example 12 | 10 | 0 | 4 |

50 g/L Active Ingredient content (480 g/L of the monopotassium salt of N-phosphonomethylglycine)

| | | % AI loss |
|---|---|---|
| | | after 4 weeks |
| Acive ingredient | pH | at 40° C. |
| primisulfuron | 5 (comparison) | 23 |
| Example 13 | 10 | 5 |
| pyriftilid | 5 (comparison) | 25 |
| Example 14 | 10 | 0 |

1. A storage-stable aqueous concentrate comprising from 0.05 to 8% w/v of an ALS inhibitor and from 35 to 70% w/v expressed as glyphosate acid equivalent of a salt of glyphosate wherein the ratio of the cation to the N-phosphonomethylglycine anion in the salt of glyphosate is from 1.5 to 3.0.

2. A concentrate according to claim 1 wherein the ALS inhibitor has a loss through hydrolysis of more than 15% by weight at a temperature of 20° C. over a period of 6 weeks in water at a concentration of 0.3% w/v.

3. A concentrate according to claim 1 wherein the ALS inhibitor is a sulfonylurea.

4. A concentrate according to claim 1 wherein the concentration of the ALS inhibitor in the composition is from 0.1 to 5% w/v.

5. A concentrate according to claim 1 wherein the ratio of the cation to the N-phosphonomethylglycine anion in the salt of glyphosate is preferably 2 to 3 and more preferably 2 to 2.5.

6. A concentrate according to claim 1 wherein the concentration of glyphosate is from 35% w/v to 60% w/v acid equivalent.

7. A concentrate according to claim 1 wherein there is additionally present an agriculturally acceptable salt.

8. A concentrate according to claim 7 wherein the salt is present at a concentration of from 0.1% to 15% w/v.

9. A process for the control of unwanted vegetation, in particular unwanted vegetation in a field of useful crops, said process comprising the dilution of an aqueous concentrate formulation according to claim 1 to form a ready-to-use aqueous formulation, followed by the application of a herbicidally effective amount of said ready-to-use aqueous formulation to the locus of the unwanted vegetation.

10. A process according to claim 9 wherein the ALS inhibitor is trifloxysulfuron, and the crop is glyphosate tolerant cotton.
